(19) United States
(12) Patent Application Publication
(10) Pub. No.: US 2007/0055861 A1
(43) Pub. Date: Mar. 8, 2007

(54) System and method for hyper-chaos secure communication

(76) Inventors: Wen-Wei Lin, Taipei (TW); Chung-Hsi Li, Ban Chiao City (TW)

Correspondence Address: TROXELL LAW OFFICE PLLC, SUITE 1404, 5205 LEESBURG PIKE, FALLS CHURCH, VA, 22041, US

(21) Appl. No.: 11/209,611

(22) Filed: Aug. 24, 2005

(51) Int. Cl. H04L 9/00

(52) U.S. Cl. 713/150

(57) ABSTRACT

A system for hyper-chaos secure communication, for conveying data confidentially from a transmitter to a receiver, includes: (1) a hyper-chaotic signal generator, for carrying a message into a first signal of the hyper-chaotic signal generator; (2) a transmitter's adjusting parameter device, for adjusting a first inner coupling parameter of the hyper-chaotic signal generator, causing the hyper-chaotic signal generator transforming the message and the first signal into a hyper-chaotic message; (3) a hyper-chaotic synchronization receiver, for adjusting a second inner coupling parameter of the hyper-chaotic synchronization receiver via a receiver's adjusting parameter device, causing the hyper-chaotic synchronization receiver generating a second signal to realize simplex-coupling asymptotical synchronization with the first signal after the receiver receiving the hyper-chaotic message; and (4) a recovery device, for obtaining a difference between the hyper-chaotic message and the second signal, inputting the difference and translating the message via a recovery setting of the recovery device.

### BACKGROUND OF THE INVENTION

1. Field of the Invention

The present invention relates to a system for secure communication, and more particularly, to a system and method for hyper-chaos secure communication. The disclosure of the present invention can be applied to many kinds of communication systems, such as local area network(LAN), wide area network(WAN), Intranet, Internet, Asymmetric Digital Subscriber Line(ADSL), Integrated Services Digital Network(ISDN), Voice on Internet Protocol(VoIP), Voice call encryption, Public Switch Telephonic Network(PSTN), GSM/CDMA-200/WCDMA, 2G/3G mobile network, IP wireless Network, WiFi/Wimax, Data encryption or real time streaming.

2. Description of the Prior Art

As computer and Internet are used widely, safety communication is getting more important. In common digital communications, most data are not encrypted and decrypted, that is, most digital communications are not confidential.

The inventors of the present invention, Li, et al., have disclosed “System and a method for handling laser-communication multiplexing in chaotic secure communications” in U.S. Pat. No. 6,744,794. Li, et al. teach “by using a low-pass filter, a chaotic time sequence of lower fractal dimension can be effectively increased to a chaotic time sequence of higher fractal dimensional, so that the periodicity of the multiplex signals will be enhanced and hence the decoding of messages from the chaotic laser signals become possible”. Li, et al. further teach “the scheme of chaotic secure communications utilizes the behavior of extremely sensitive dependence on initial conditions and the feature of randomness of the chaotic laser light”. Li, et al. further teach “the scheme of chaotic secure communications is achieved by adjusting the coupling parameters of the receiver system, so that the chaotic system of the receiver end is simplex coupled to the transmitter end, and thus prohibiting the transmitted messages to be rebuilt by any unauthorized receptor”.

Other confidential methods for secure communication are not mentioned or provided in U.S. Pat. No. 6,744,794, except, laser-communication.

### SUMMARY OF THE INVENTION

An objective of the present invention is to solve the above-mentioned problems and to provide a system and method for hyper-chaos secure communication. Digital data are encrypted and decrypted by the hyper-chaos technique. The encrypted and decrypted digital data are transferred through wire or wireless, thus, the secure communication achieved.

The present invention achieves the above-indicated objective by providing a system for hyper-chaos secure communication. The system for hyper-chaos secure communication, for conveying data confidentially from a transmitter to a receiver, includes following elements: (1) a hyper-chaotic signal generator, located in the transmitter for carrying a message into a first signal of the hyper-chaotic signal generator; (2) a transmitter's adjusting parameter device, located in the transmitter for adjusting a first inner coupling parameter of the hyper-chaotic signal generator, causing the hyper-chaotic signal generator transforming the message and the first signal into a hyper-chaotic message and causing the transmitter sending the hyper-chaotic message to the receiver; (3) a hyper-chaotic synchronization receiver, located in the receiver for adjusting a second inner coupling parameter of the hyper-chaotic synchronization receiver via a receiver's adjusting parameter device, causing the hyper-chaotic synchronization receiver generating a second signal to realize simplex-coupling asymptotical synchronization with the first signal after the receiver receiving the hyper-chaotic message; and (4) a recovery device, located in the receiver for obtaining a difference between the hyper-chaotic message and the second signal, inputting the difference and translating the message via a recovery setting of the recovery device.

According to another aspect of the present invention, a method for hyper-chaos secure communication, for conveying data confidentially from a transmitter to a receiver, wherein the transmitter having a hyper-chaotic signal generator and the receiver having a hyper-chaotic synchronization receiver, comprising the steps of: carrying a message into a first signal of the hyper-chaotic signal generator; adjusting a first inner coupling parameter of the hyper-chaotic signal generator, causing the hyper-chaotic signal generator transforming the message and the first signal into a hyper-chaotic message and causing the transmitter sending the hyper-chaotic message to the receiver; adjusting a second inner coupling parameter of the hyper-chaotic synchronization receiver, causing the hyper-chaotic synchronization receiver generating a second signal to realize simplex-coupling asymptotical synchronization with the first signal after the receiver receiving the hyper-chaotic message; obtaining a difference between the hyper-chaotic message and the second signal and inputting the difference; and translating the message via a recovery setting.

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is a block diagram of the system for hyper-chaos secure communication in the embodiment 1 of the present invention.

FIG. 2 is a block diagram for illustrating the procedure of the hyper-chaotic signal generator in the embodiment 1 of the present invention.

FIG. 3 is a block diagram for illustrating the procedure of the hyper-chaotic synchronization receiver in the embodiment 1 of the present invention.

FIG. 4 is a flow chart showing the steps for the hyper-chaos secure communication in the embodiment 1 of the present invention.

FIG. 5 is a block diagram of the second system for hyper-chaos secure communication in the embodiment 2 of the present invention.

### DETAILED DESCRIPTION OF THE PREFERRED EMBODIMENTS

A system and method for hyper-chaos secure communication is used to apply the hyper-chaos technique in the secure communication with digital data encrypted and decrypted. The encrypted and decrypted digital data by the hyper-chaos technique are transferred through wire or wireless, thus, the secure communication achieved.

### EMBODIMENT 1

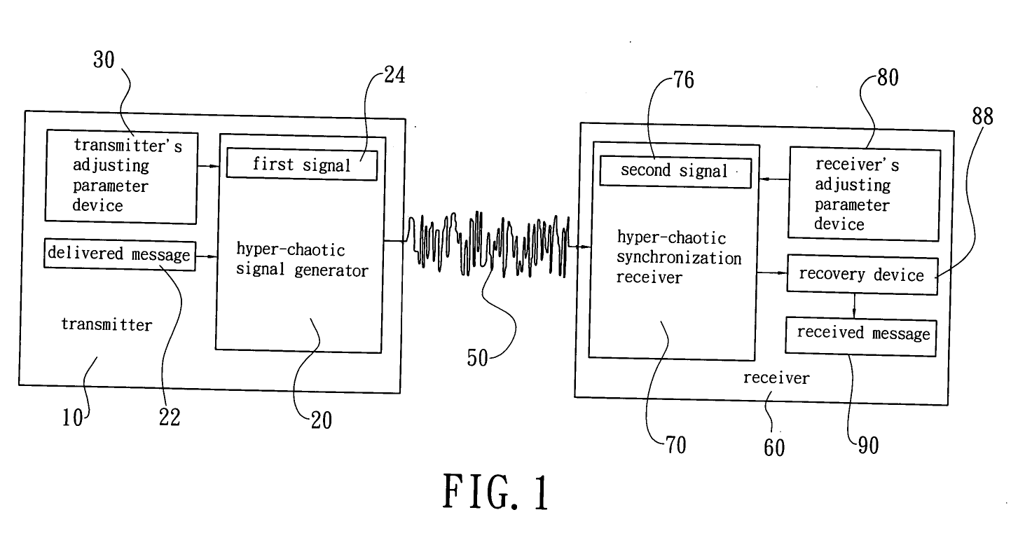

FIG. 1 is a block diagram of the system for hyper-chaos secure communication in the embodiment 1. As shown in FIG. 1, the system includes a transmitter 10 and a receiver 60. The transmitter 10 includes a hyper-chaotic signal generator 20 and a transmitter's adjusting parameter device 30. The hyper-chaotic signal generator 20 is located in the transmitter. The hyper-chaotic signal generator 20 is used for carrying a delivered message 22 into a first signal 24 of the hyper-chaotic signal generator 20.

The transmitter's adjusting parameter device 30 in the embodiment 1 is located in the transmitter. The transmitter's adjusting parameter device 30 is used for adjusting a first inner coupling parameter of the hyper-chaotic signal generator 20, causing the hyper-chaotic signal generator 20 transforming the delivered message 22 and the first signal 24 into a hyper-chaotic message 50 and causing the transmitter 20 sending the hyper-chaotic message 50 to the receiver 60. The hyper-chaotic message 50 can be sent by the hyper-chaotic signal generator 20 in the embodiment 1.

The receiver 60 includes a hyper-chaotic synchronization receiver 70 and a receiver's adjusting parameter device 80. The hyper-chaotic synchronization receiver 70 is located in the receiver 60. The receiver's adjusting parameter device 80 is used for adjusting a second inner coupling parameter of the hyper-chaotic synchronization receiver 70, causing the hyper-chaotic synchronization receiver 70 generating a second signal 76 to realize simplex-coupling asymptotical synchronization with the first signal 24 after the receiver 60 receiving the hyper-chaotic message 50.

As shown in FIG. 1, a recovery device 88 is located in the receiver 60. The recovery device 88 is used for obtaining a difference between the hyper-chaotic message 50 and the second signal 76, inputting the difference and translating the delivered message 22 via a recovery setting of the recovery device 88. Thus, a received message 90 is gotten by translating the delivered message 22 via the recovery setting.

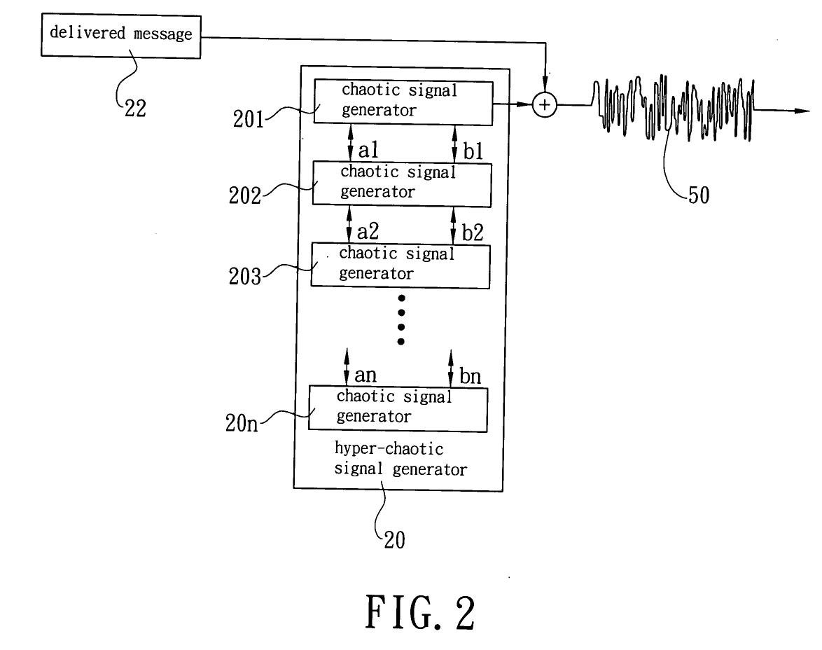

FIG. 2 is a block diagram for illustrating the procedure of the hyper-chaotic signal generator 20 in the embodiment 1. The hyper-chaotic signal generator 20 generates the first signal 24 by means of a plurality of chaotic signal generators 201, . . . , 20n coupling with each other. Then, the delivered message 22 is carried into the first signal 24 to transform into the hyper-chaotic message 50. The hyper-chaotic message 50 is sent after it is formed. The hyper-chaotic message 50 can be sent by the hyper-chaotic signal generator 20 in the embodiment 1.

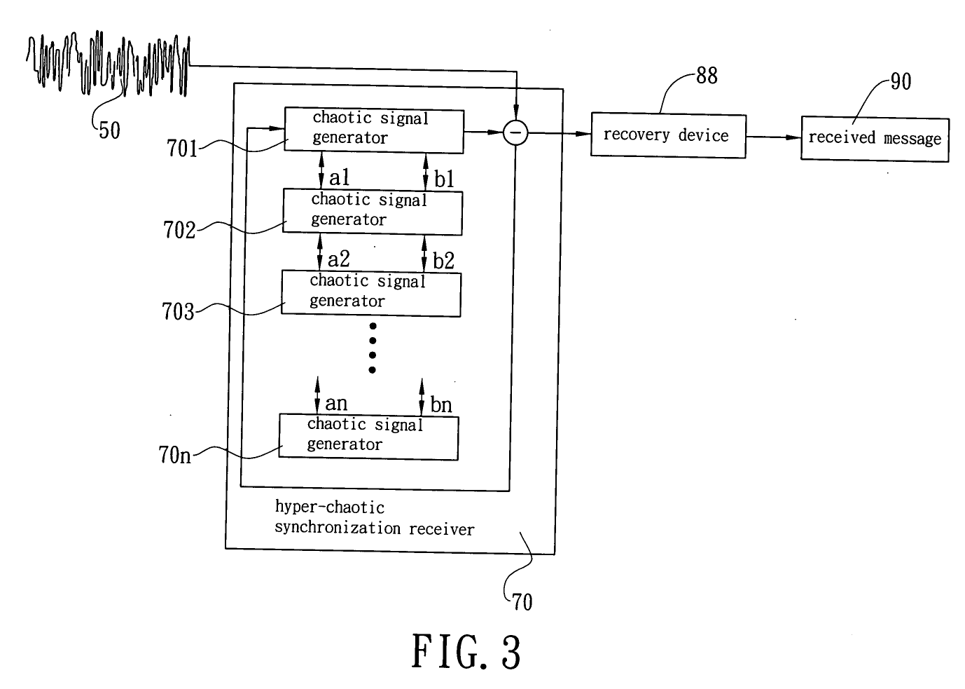

FIG. 3 is a block diagram for illustrating the procedure of the hyper-chaotic synchronization receiver 70 in the embodiment 1. The hyper-chaotic synchronization receiver 70 generates the second signal 76 by means of a plurality of chaotic signal generators 701, . . . , 70n coupling with each other. The simplex-coupling asymptotical synchronization is realized by means of simplex coupling of the hyper-chaotic message 50 after the receiver 60 receiving the hyper-chaotic message 50. Then, the second signal 76 of the hyper-chaotic synchronization receiver 70 of the receiver 60 and the first signal 24 of the hyper-chaotic signal generator 20 of the transmitter 10 achieve simplex-coupling asymptotical synchronization.

The transmitter's or receiver's adjusting parameter device of the system for hyper-chaos secure communication in the embodiment 1 has parameters a1, . . . , an and b1, . . . , bn preferably in the range 0.01-1 and 0.89-1 respectively, more preferably in the range 0.01-0.11 and 0.89-0.99 respectively.

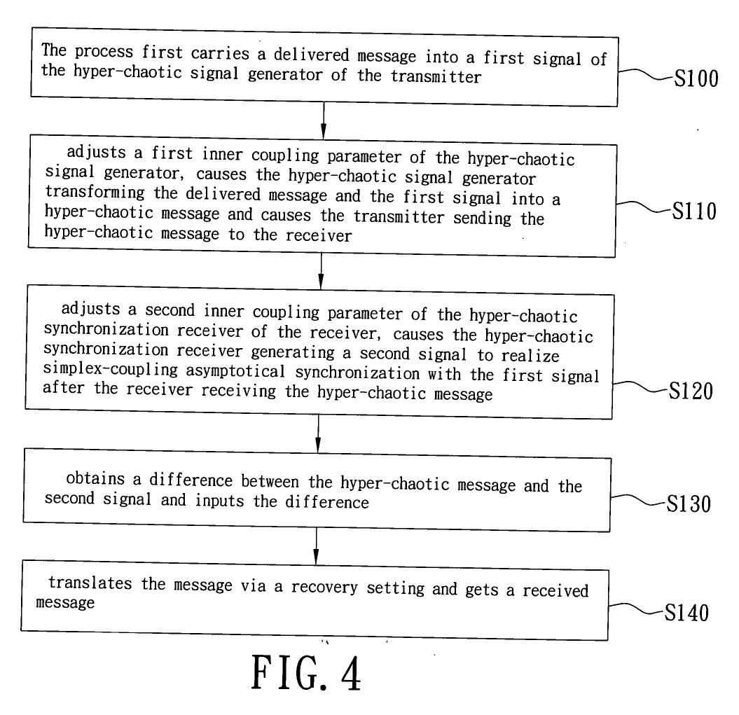

FIG. 4 is a flow chart showing the steps for the hyper-chaos secure communication in the embodiment 1. The method for hyper-chaos secure communication is used for conveying data confidentially from a transmitter 10 to a receiver 60. The transmitter 10 has a hyper-chaotic signal generator 20 and the receiver 60 has a hyper-chaotic synchronization receiver 70. The process first carries a delivered message 22 into a first signal 24 of the hyper-chaotic signal generator 20 of the transmitter 10, as shown in step S100.

In step S110, the process adjusts a first inner coupling parameter of the hyper-chaotic signal generator 20, causes the hyper-chaotic signal generator 20 transforming the delivered message 22 and the first signal 24 into a hyper-chaotic message 50 and causes the transmitter 10 sending the hyper-chaotic message 50 to the receiver 60.

In step S120, the process adjusts a second inner coupling parameter of the hyper-chaotic synchronization receiver 70 of the receiver 60, causes the hyper-chaotic synchronization receiver 70 generating a second signal 76 to realize simplex-coupling asymptotical synchronization with the first signal 24 after the receiver 60 receiving the hyper-chaotic message 50.

In step S130, the process obtains a difference between the hyper-chaotic message 50 and the second signal 76 and inputs the difference.

Finally, in step S140, the process translates the message via a recovery setting and gets a received message 90.

### EMBODIMENT 2

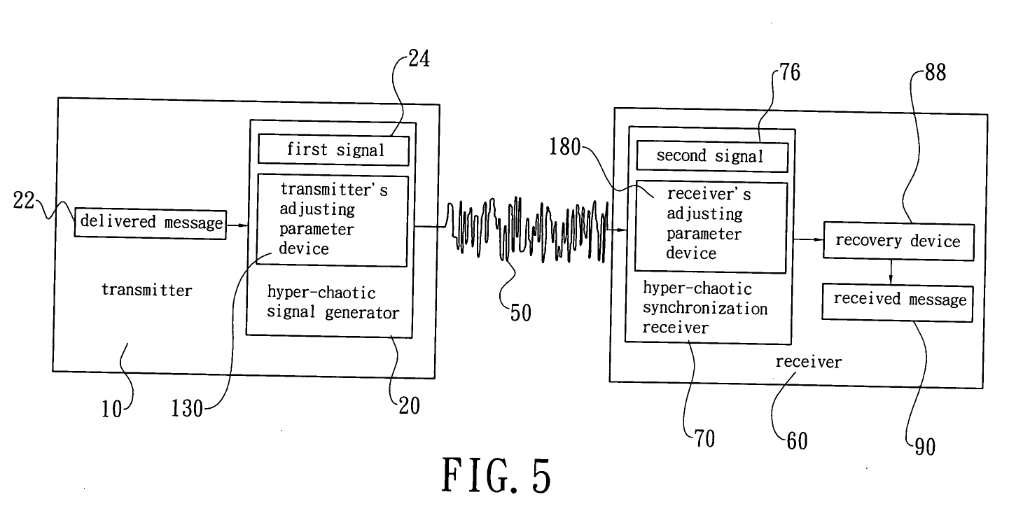

FIG. 5 is a block diagram of the second system for hyper-chaos secure communication in the embodiment 2. As shown in FIG. 5, the second system is, except as described below, similar to the first system and like reference numerals are used to indicate like parts with the same structure and function.

Differences between the second system and the first system are that a transmitter's adjusting parameter device 130 is located in the hyper-chaotic signal generator 20 and a receiver's adjusting parameter device 180 is located in the hyper-chaotic synchronization receiver 70. Except above mentions, the other techniques are like.

What is claimed is:

1. A system for hyper-chaos secure communication, for conveying data confidentially from a transmitter to a receiver, comprising:
a hyper-chaotic signal generator, located in the transmitter for carrying a message into a first signal of the hyper-chaotic signal generator;
a transmitter's adjusting parameter device, located in the transmitter for adjusting a first inner coupling parameter of the hyper-chaotic signal generator, causing the hyper-chaotic signal generator transforming the message and the first signal into a hyper-chaotic message and causing the transmitter sending the hyper-chaotic message to the receiver;
a hyper-chaotic synchronization receiver, located in the receiver for adjusting a second inner coupling parameter of the hyper-chaotic synchronization receiver via a receiver's adjusting parameter device, causing the hyper-chaotic synchronization receiver generating a second signal to realize simplex-coupling asymptotical synchronization with the first signal after the receiver receiving the hyper-chaotic message; and
a recovery device, located in the receiver for obtaining a difference between the hyper-chaotic message and the second signal, inputting the difference and translating the message via a recovery setting of the recovery device.

2. The system for hyper-chaos secure communication as recited in claim 1, wherein the transmitter's adjusting parameter device is located in the hyper-chaotic signal generator.

3. The system for hyper-chaos secure communication as recited in claim 1, wherein the receiver's adjusting parameter device is located in the hyper-chaotic synchronization receiver.

4. The system for hyper-chaos secure communication as recited in claim 1, wherein the transmitter sending the hyper-chaotic message to the receiver is via the hyper-chaotic signal generator.

5. The system for hyper-chaos secure communication as recited in claim 1, wherein the transmitter's or receiver's adjusting parameter device has parameters a1, . . . , an and b1, . . . , bn in the range 0.01-1 and 0.89-1 respectively.

6. The system for hyper-chaos secure communication as recited in claim 1, wherein the transmitter's or receiver's adjusting parameter device has parameters a1, . . . , an and b1, . . . , bn in the range 0.01-0.11 and 0.89-0.99 respectively.

7. The system for hyper-chaos secure communication as recited in claim 1, wherein the system is local area network(LAN), wide area network(WAN), Intranet, Internet, Asymmetric Digital Subscriber Line(ADSL), Integrated Services Digital Network(ISDN), Voice on Internet Protocol(VoIP), Voice call encryption, Public Switch Telephonic Network(PSTN), GSM/CDMA-200/WCDMA, 2G/3G mobile network, IP wireless Network, WiFi/Wimax, Data encryption or real time streaming.

8. A method for hyper-chaos secure communication, for conveying data confidentially from a transmitter to a receiver, wherein the transmitter having a hyper-chaotic signal generator and the receiver having a hyper-chaotic synchronization receiver, comprising the steps of:
carrying a message into a first signal of the hyper-chaotic signal generator;
adjusting a first inner coupling parameter of the hyper-chaotic signal generator, causing the hyper-chaotic signal generator transforming the message and the first signal into a hyper-chaotic message and causing the transmitter sending the hyper-chaotic message to the receiver;
adjusting a second inner coupling parameter of the hyper-chaotic synchronization receiver, causing the hyper-chaotic synchronization receiver generating a second signal to realize simplex-coupling asymptotical synchronization with the first signal after the receiver receiving the hyper-chaotic message;
obtaining a difference between the hyper-chaotic message and the second signal and inputting the difference; and
translating the message via a recovery setting.

9. The method for hyper-chaos secure communication as recited in claim 8, wherein the transmitter sending the hyper-chaotic message to the receiver is via the hyper-chaotic signal generator.

10. The method for hyper-chaos secure communication as recited in claim 8, wherein the transmitter's or receiver's adjusting parameter device has parameters a1, . . . , an and b1, . . . , bn in the range 0.01-1 and 0.89-1 respectively.

11. The method for hyper-chaos secure communication as recited in claim 8, wherein the transmitter's or receiver's adjusting parameter device has parameters a1, . . . , an and b1, . . . , bn in the range 0.01-0.11 and 0.89-0.99 respectively.

12. The method for hyper-chaos secure communication as recited in claim 8, wherein the method is suitable for local area network(LAN), wide area network (WAN), Intranet, Internet, Asymmetric Digital Subscriber Line(ADSL), Integrated Services Digital Network(ISDN), Voice on Internet Protocol(VoIP), Voice call encryption, Public Switch Telephonic Network(PSTN), GSM/CDMA-200/WCDMA, 2G/3G mobile network, IP wireless Network, WiFi/Wimax, Data encryption or real time streaming.
